(19) United States
(12) Patent Application Publication
(10) Pub. No.: US 2003/0191670 A1
(43) Pub. Date: Oct. 9, 2003

(54) Medication compatibility profile data system

(76) Inventors: Edwin Bruce Hatcher, Wayne, WV (US); Steven Thomas De Luca, Louisville, KY (US)

Correspondence Address: Edwin Bruce Hatcher, 349 Roanoke Circle, Wayne, WV, 25570, US

(21) Appl. No.: 10/402,412

(22) Filed: Mar. 28, 2003

Related U.S. Application Data
(60) Provisional application No. 60/370,399, filed on Apr. 8, 2002.

(51) Int. Cl. G06F 17/60

(52) U.S. Cl. 705/2

(57) ABSTRACT

A business model for an information database and network, designed specifically for the analysis of the impact upon medical patients and supplement-herb consumers with respect to (1) the consumption of different medications and pharmaceuticals, (2)the consumption of different supplements and herbs, and (3) the consumption of medications and supplements and herbs in order to produce a medication consumption schedule automatically.

The medication schedule is formulated pursuant to information contained in published medication, supplement, herb, and herbal formulation monographs, which provide critical information about cautions, contraindications, description, dosage amount, frequency, interactions, separations, side-effects, and warnings.

The business model is fully compatible with Internet networks to provide real-time network connectivity and interaction between physicians, hospitals, pharmacies, health care professionals, and individual patients.

### CROSS-REFERENCE TO RELATED APPLICATIONS

A Provisional Patent Application was filed Apr. 8, 2002, United States Patent and Trademark Office, Washington, D.C.

Application Number—No. 60/370,399

Confirmation Number—4531

Filing Date—Apr. 8, 2002

### STATEMENT REGARDING FEDERALLY SPONSORED RESEARCH OR DEVELOPMENT

This application is not made with respect to rights to any invention made under federally sponsored research and development.

### REFERENCE TO SEQUENCE LISTING, A TABLE, OR A COMPUTER PROGRAM LISTING COMPACT DISK APPENDIX

This application does not require a Sequence Listing, a Table, or a Computer Program Listing Compact Disk Appendix.

### BACKGROUND OF THE INVENTION

One of five Americans (22%) report that they or a family member experienced a medical error of some kind. One of ten adults reported that their own or a family members illness condition had become worse as a result of a mistake in a doctor's office or in the hospital, and about half of those reported that the problem was very serious. Of the 16% reporting a medication error, over one-fifth indicated that the error turned out to be a very serious problem. Nationally, these facts translate into an estimated 22.8 million people reporting at least one family member who experienced a mistake, and 8.1 million households reporting at least one family member had a problem that was serious because of medical and medication mistakes. This on-going circumstance suggests that the Institute of Medicine's 1999 report To Err Is Human, which estimated that there are 44,000 to 98,000 deaths annually due to medical errors, may be just the tip of the iceberg in determining the full extent of injuries from medical errors.

There are many instances where an individual patient may provide valuable assistance to medical practitioners with the proper tools to do so. For many and varied reasons doctors, pharmacists, and others who either sell and/or dispense medications, supplements, herbs and herbal formulations of all types, do not or cannot know the actual circumstances of the daily diet and lifestyle of individual patients. To a large degree, review of the interaction consequences of diet, medications, supplements, herbs and herbal formulations, by individual patients, with the proper tools, could save lives.

Pursuant to the fact of:

a. the existence of varying and confusing terminology used to convey information about medication, supplement and herbal side-effects, contraindications, cautions, disease interactions, food interactions, and warnings, in most medication monographs, and

b. the confusing references and cross-references compiled within the structure of most medication monographs, and

c. the total lack of individual patient access to multiple medication profile information databases, most individual patients have no way to double check, for themselves, the possible consequences of mixing food, medications, supplements, and herbs in a manner customized to their own individual circumstantial diet and lifestyle.

Historically, medical patients have entrusted their health and ultimately their lives to medical practitioners. Many medical practitioners and health care providers, for various reasons, find it impossible to provide the time, attention, and effort, on an individual basis, to produce a thorough and painstaking evaluation and report for each individual patient about the dramatic and often deadly consequences of introducing toxic medications that may interact with other foods, drugs, medications, supplements, herbs, and herbal formulations, being consumed.

Upon this background, the Medication Compatibility Profile Data System (MCPDS) has been invented to fill in the chasm devoid of critical information about medications, supplements, and herbs, and their interactions in a manner that will allow all persons involved in medical care, including the patient, to access a medication, supplement, and herb monograph database, or databases, that will provide critical feedback in a customized report for an individual patient.

### SUMMARY OF THE INVENTION

The Medication Compatibility Profile Data System, (MCPDS) is a database information service primarily and directly intended to benefit the patients-customers of physicians, pharmacists, and other health care professionals, and; significantly reduce the prevalent incidence of the potentially harmful or fatal errors associated with improper consumption schedules of medications—supplements—herbs.

A lack of cross-referenced medication—supplement—herb monograph data and the present lack of any computer applications to integrate such a cross reference to the dosage frequency schedule for multiple applications of medications—supplements—herbs, on an individual and customized basis, gives rise to the danger of improper consumption of such substances. Such dangerous circumstances may lead to potentially damaging or fatal mixtures of medications—supplements—herbs.

MCPDS will address and enhance the ability of—physicians—pharmacists—health care professionals—to provide accurate and customized directions for the safe consumption of pharmaceuticals—supplements—herbs;

1. MCPDS will expand the value and availability of the information and directions for the safe, proper and effective consumption of—prescription medications—supplements—herbs.

2. MCPDS will sort, compare and analyse—medication—supplement—herb monographs, in conjunction with prescription dosage directives in order to produce a customized medication—supplement—herb consumption schedule for multiple substance therapies.

3. MCPDS will promote safe scheduling of the intake of medications—supplements—herbs—in consideration of all available monograph data and provide patients—customers with informative monograph reports.

MCPDS is basically a software application, compatible with operating systems for

(1) personal computers,

(2) the Internet

(3) hand-held wireless data storage and transfer devices, and

(4) mobile dispensers.

MCPDS will significantly enhance the health-safety of medication—supplement—and herb consumers.

MCPDS will effectively fill-in the gap between medical and health professionals that presently exists when the user of medications—supplements—herbs attempts to create a schedule for taking multiples of such medications—supplements—herbs.

MCPDS will construct a schedule for taking multiple medications—supplements—herbs on a case-by-case basis.

With available technology, MCPDS will be packaged and configured to function within the unique and specific work environments of physicians, pharmacists, and health industry professionals. MCPDS will substantially expand their respective markets and revenue by delivering increased knowledge and safety to their respective customers about the medications—supplements—herbs being consumed.

MCPDS fills the void in the medication—supplement—herb market with respect to access to a working database of authoritative data to develop and generate compatible medication therapy schedules and provide warnings against dangerous combinations, a patient safety consideration presently not addressed.

MCPDS provides the availability of practical directions and a pharmaceutical—supplement—herb dosage schedule which correctly and properly provides critical information about the consumption of multiple forms of pharmaceuticals—supplements—herbs. Information that removes the doubt and anxiety spawned by trying to make sense of all the disjointed and separate data provided for proper and safe consumption of individual medicines—supplements—herbs.

The MCPDS medication schedule will make available a suggested dosage schedule for all medications taken by a single patient, supplied by the Pharmacist-Healthcare Specialist; providing an enormous benefit to all concerned with the health and care of a family member or friend.

The ultimate focus of the invention is the creation of a compelling value by providing an identified critical need in the medical and health supplement markets—patient safety, and reduction of medication errors.

MCPDS provides a unique one-of-a-kind service through the power of database resource availability to generate customized medication—supplement—herb dosage schedules. The system will re-package crucial medical data in a readily available and convenient form. MCPDS software can collate and produce reports and schedules from authorized data sources at the touch of a button, when accessed by participating physicians, pharmacists and health care professionals, anywhere, anytime.

MCPDS provides the health care professional with instant secure access to critical medication—supplement—herb monographs and dosage schedules customized to the customer's specific needs. The system's functional design is fully integrated with Internet technology to function on wireless hand-held devices which will enable a physician to access patient data through the office or hospital MCPDS computer and wirelessly through existing telephone systems. Physicians will be able to transmit by secure email protocols, prescription orders directly to participating pharmacies.

MCPDS software will drive an optional medication dispenser which will control scheduled release of prescribed medications. The dispenser must be returned to the pharmacy for refills and updates to medication therapy. Any tampering will terminate the medication release program and page the pharmacy about the suspicious event.

### BRIEF DESCRIPTION OF THE DRAWINGS

FIG. 1 is a partial drawing depicting the information data flow of information from a portable wireless communication device used by a physician, and shows the data path through the wireless communication system to the physicians office based network computer and the Internet and the connection to a pharmacy data flow network.

FIG. 2 is a partial drawing depicting the information data flow of information from a portable wireless communication device used by a pharmacist, and shows the data path through the wireless communication system to the pharmacy based network computer and the Internet and the connection to a physicians data flow network.

FIG. 3 depicts the information data flow of information from a portable wireless communication device used by an alternative health care specialist, and shows the data path through the wireless communication system to the store or office based network computer and the Internet data flow network.

FIG. 4 depicts the information data flow of information from a portable wireless communication device used by an individual subscriber medical patient, and shows the data path through the wireless communication system to a home based network computer and the Internet data flow network.

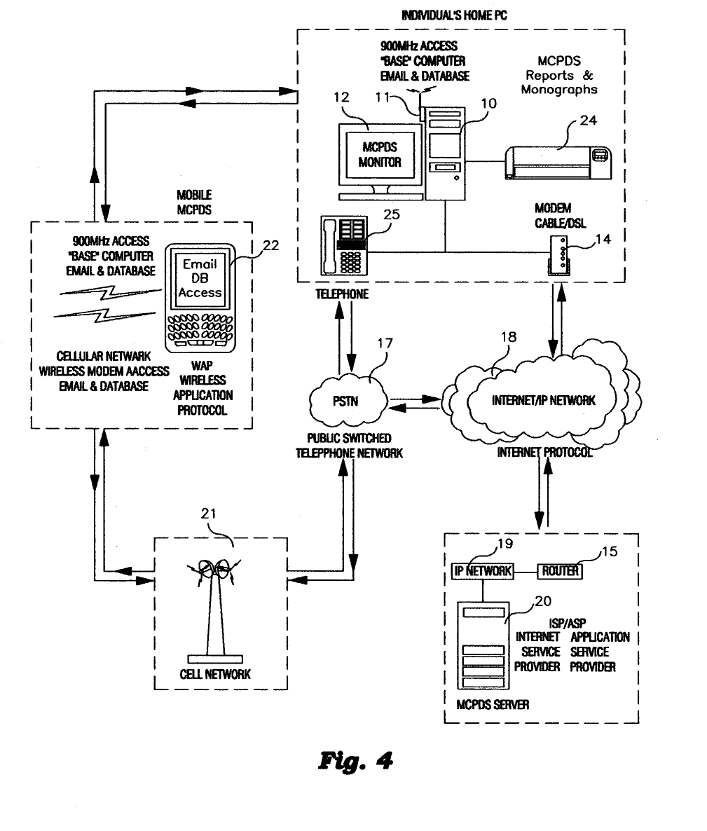

FIG. 5 is the symbol legend describing the meaning of flow chart symbols used to describe the logic and system operational sequences employed to effect operation of the Medication Compatibility Profile Data System (MCPDS).

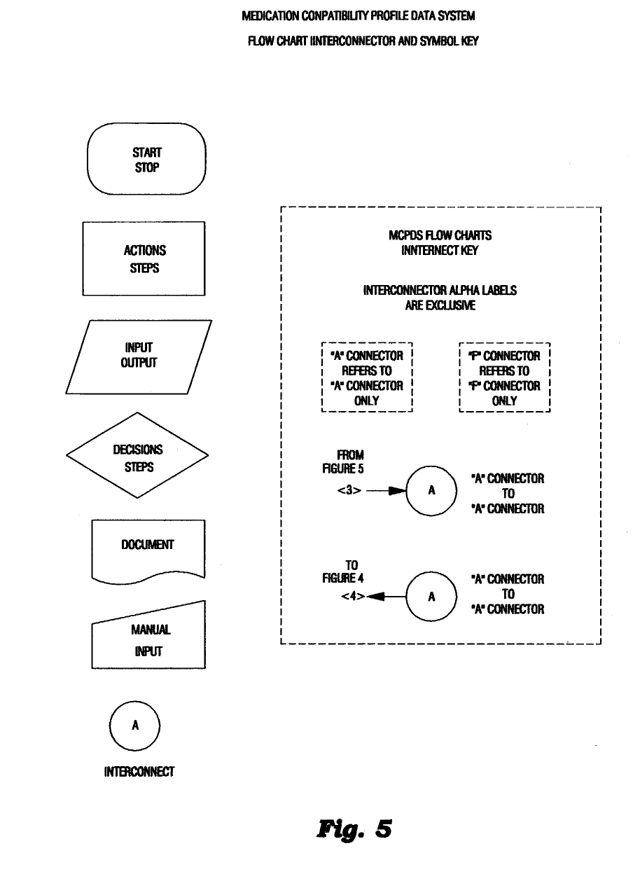

FIG. 6 depicts an overview of the system and the major routing paths through the Internet.

FIG. 7 depicts system information input to a physician's office computer system, and the connector “NPA” which connects this drawing to FIG. 21 drawing.

FIG. 8 depicts system information input to a physician's handheld network communication device, and the connector “NPA” which connects this drawing to FIG. 21 drawing.

FIG. 9 is a partial drawing depicting physicians data entry through a hospital's computer network and the connectors “A”, “B”, and “NPA” which connect to FIG. 10 and FIG. 21 drawings respectively.

FIG. 10 is a partial drawing depicting physicians data entry through a hospital's computer network, hospital nurse's station, and individual patient monitoring network, and the connectors “A”, “B”, and “F” which connect to FIG. 9 and FIG. 11 drawings respectively.

FIG. 11 is a partial drawing depicting hospital based medication dispenser connection to the MCPDS network the connectors “F” which connect to FIG. 10.

FIG. 12 is a partial drawing depicting pharmacist's data entry through the MCPDS Internet based network and the connectors “NPA”, “I”, and “G” which connect to FIG. 21, FIG. 20, and FIG. 13 drawings respectively.

FIG. 13 is a partial drawing depicting pharmacist's data entry through the MCPDS Internet based network and generation of customized medication compatibility profile schedule, medication labels, and medication monograph reports, and the connectors “D”, “E”, “F”, and “G” which connect to FIG. 14, FIG. 15, FIG. 16, and FIG. 12 drawings respectively.

FIG. 14 is a partial drawing depicting pharmacist's data entry through the MCPDS in-store network for generating drug container labels and the connectors “D”which connect to FIG. 13.

FIG. 15 is a partial drawing depicting pharmacist's data entry through the MCPDS in-store network for generating drug monographs and the connectors “E” and “H” which connect to FIG. 13 and FIG. 14 respectively.

FIG. 16 is a partial drawing depicting pharmacist's data entry through the MCPDS in-store network for programming and loading of an MCPDS Medication Dispenser and the connector “F” which connects to FIG. 14 and FIG. 21 respectively.

FIG. 17 is a partial drawing depicting alternative health care professional's data entry through the MCPDS network and the connector “NPA” which connects to FIG. 21.

FIG. 18 is a partial drawing depicting an individual user's data entry through the MCPDS network for access to medication record stored in the MCPDS database and for inquiry about mixing different medications, supplements, herbs, and herbal remedies.

FIG. 19 is a partial drawing depicting the MCPDS Medication Schedule program functions for creating new patient accounts and data entry and the connectors “NPA” and “H” which connect to FIG. 21 and FIG. 20 respectively.

FIG. 20 is a partial drawing depicting a continuation of MCPDS Medication Schedule program functions for creating new patient accounts, updating patient accounts, data entry and the connectors “H” and “I” which connect to FIG. 15, FIG. 19, and FIG. 12 respectively.

FIG. 21 is a partial drawing depicting the MCPDS new patient account personal information elements to be entered into the database, and the connectors “F”, “J”, and “NPA” which connect to FIG. 16, FIG. 22, FIG. 7, FIG. 8, FIG. 9, FIG. 12, FIG. 17, and FIG. 19 respectively.

FIG. 22 is a partial drawing depicting the MCPDS new patient account medical information elements to be entered into the database, and the connectors “J” and “NPA” which connect to FIG. 21, FIG. 7, FIG. 8, FIG. 9, FIG. 12, FIG. 17, and FIG. 19 respectively.

FIG. 23 is a drawing depicting the MCPDS database information elements that are required for standard drug container labels.

FIG. 24 is a drawing depicting an MCPDS Medication Schedule.

### DETAILED DESCRIPTION OF THE INVENTION

MCPDS is basically a software application for producing medication schedules, to be used within the scope of this business model. The system is designed to be compatible with operating systems for: (1) personal computers, (2) the Internet, (3) hand-held wireless data storage and transfer devices, (4) mobile medication dispensers.

### Component Parts of the Internet Online Product

1) Medication Schedule

2) Medication—supplement—herb database

3) Physicians database

4) Pharmacists database

5) Alternative Health Care Professionals database

6) Patient-Customer database

7) Label maker system

8) Email system

9) Wireless pager/email device

10) Medication Safety Dispenser (MSD)

I. Physician MCPDS Users.

(A) Physician's Office PC Access.

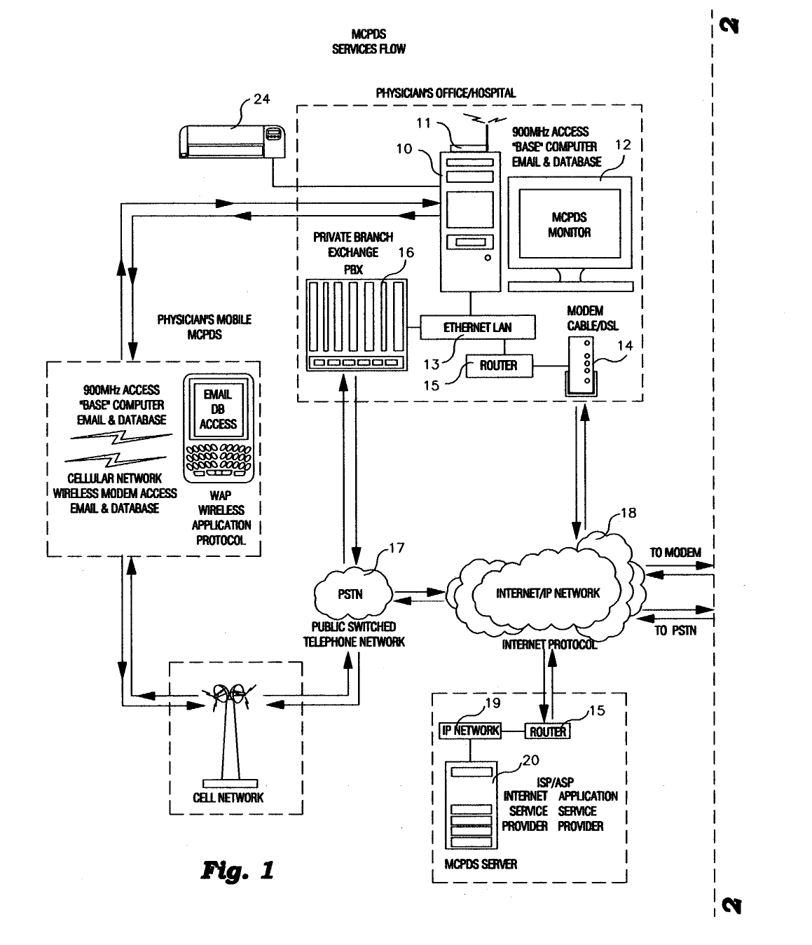

(1) Using the office personal computer system FIG. 1, item 10, a secure Login code is entered to access Physician's account in MCPDS Internet online database through wired or wireless connections to a local area network (LAN) device FIG. 1, item 13, Internet connection router FIG. 1, item 15, appropriate dial-up-cable-DSL modem FIG. 1, item 14, to the Internet Providers network FIG. 1, item 18. At least one unique and secure account access code is assigned to each Physician master account containing all patient data. Individual patient accounts may again be password protected to provide a second level of security for patient medical information.

(2) After successful secure login to the physician's patient database account, separate patient accounts may be created and accessed. Each patient file is unique and accessible only by physician's unique login security code.

(3) Every database and individual account access is marked and logged. Every access and data entry activity to accounts are automatically date and time stamped by the MCPDS program.

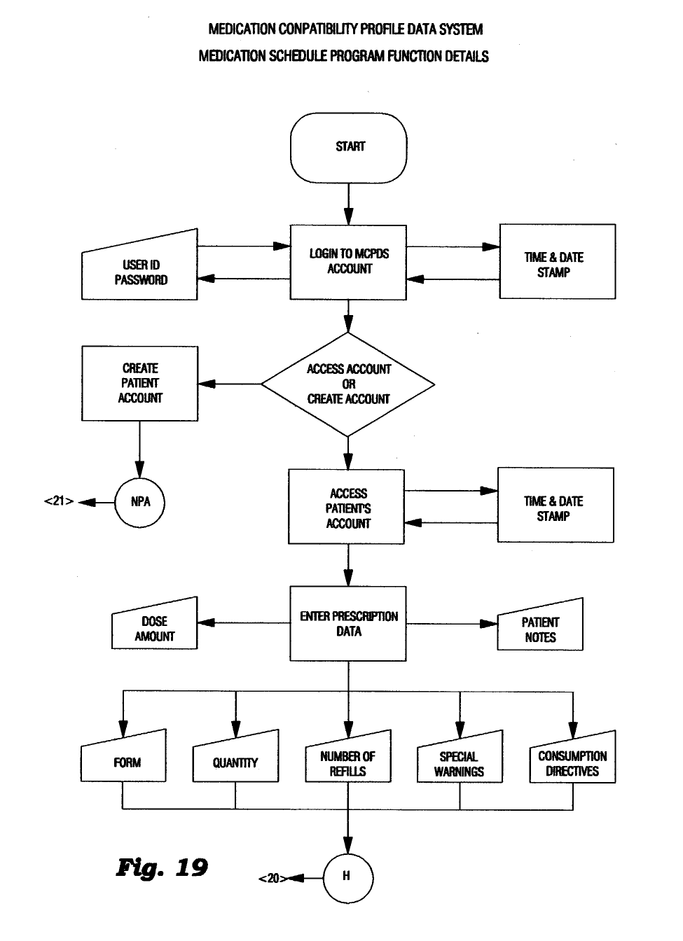

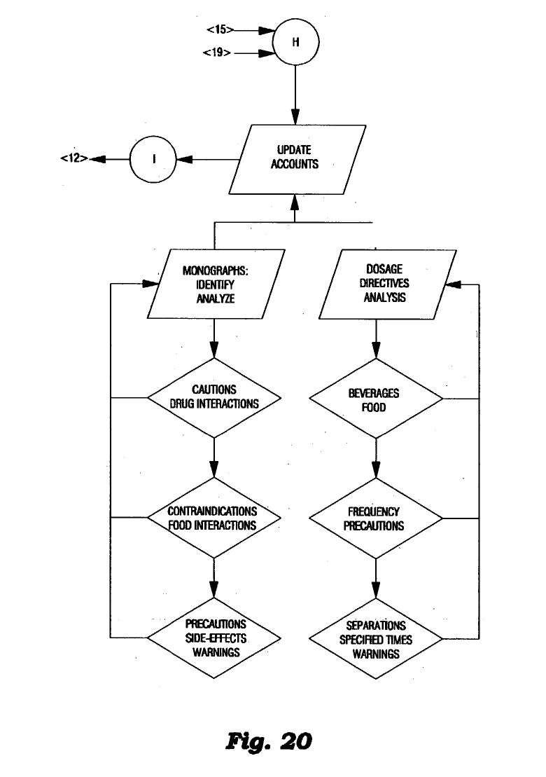

(4) Prescribed medication data is entered into an individual patient database, if multiple substances are prescribed, the MCPDS program will generate an MCPDS Medication Schedule and monograph report for review by both physician and patient which can then be printed and delivered to the patient. Other substances such as supplements and herbs, presently being consumed, may also be entered and the monographs for those elements will also be used by MCPDS to develop the Medication Schedule. See FIGS. 19 and 20 for logic flow detail operations performed by the MCPDS program in development of the Medication Schedule.

(5) All information, notes and comments necessary to administer medical care for an individual patient are entered into that patient's record files in the MCPDS secure Internet online database 20, which can be accessed by authorized persons, from any location through an Internet connection. Physicians may also maintain their own Internet server computer system for added security and restricted possession of the information stored in the MCPDS server database.

(6) Through the MCPDS Internet network, a secure transmission of prescription orders may be forwarded to a designated Pharmacy. The physician may opt to electronically transmit the prescription order directly to the patient's pharmacy computer via secure email, eliminating copy errors and mistranslation of prescription details.

(B) Physician's Handheld Wireless Communication Device

(1) Using the physician's wireless mobile MCPDS hand-held communication device, FIG. 1, item 22, a secure Login code is entered to access Physician's account in MCPDS Internet online database through wireless connections to a transmitter/receiver computer interface, FIG. 1, item 11, connected to an office Personal Computer (PC), FIG. 1, item 10, local area network (LAN) device FIG. 1, item 13, Internet connection router FIG. 1, item 15, appropriate dial-up-cable-DSL modem FIG. 1, item 14, to the Internet Providers network FIG. 1, item 18; or through wireless telephone network, FIG. 1, item 21, public switched telephone network ((PSTN), FIG. 1, item 17, office private branch exchange or telephone, FIG. 1, item 16, LAN, FIG. 1, item 13, through router, FIG. 1, item 15, modem, FIG. 1, item 14, to the Internet Providers network FIG. 1, item 18, and on to the MCPDS server, FIG. 1, item 20.

(2) Secure access, data entry and use of the MCPDS database functions are identical to those used with the physician's office PC.

C) Physician's Access to Patient Accounts Via Hospital MCPDS PC.

(1) In the hospital, a physician may use the MCPDS secure login functions to access private individual patient accounts through Internet MCPDS online database access via physician's own wireless hand-held communication device, the hospital MCPDS PC, or any computer terminal with an Internet connection. Physician's private MCPDS database may be accessed in the same manner described in paragraphs (A)(1) through (A)(6) to administer individual patient accounts and data entry, and also to create new patient accounts.

(2) The physician may also directly and securely transmit prescription orders to the Hospital Pharmacy eliminating copy errors and mistranslation of prescription details.

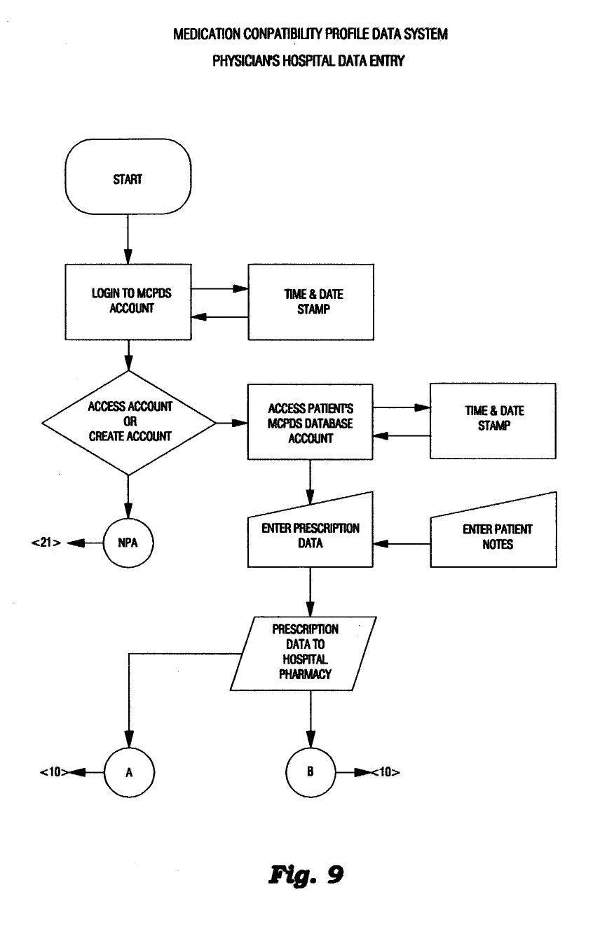

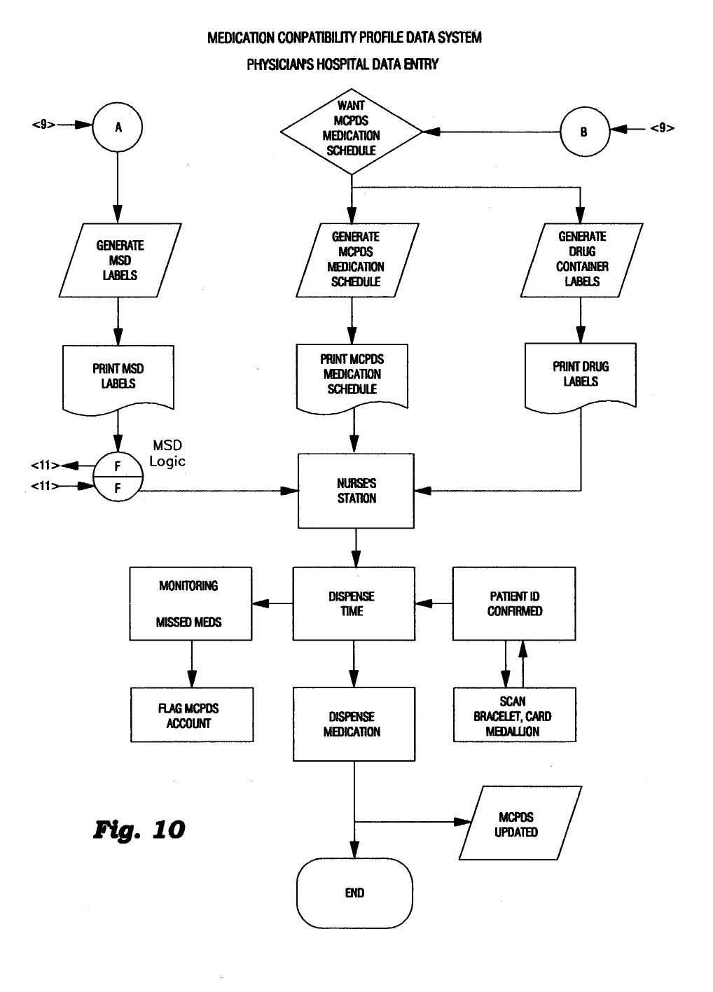

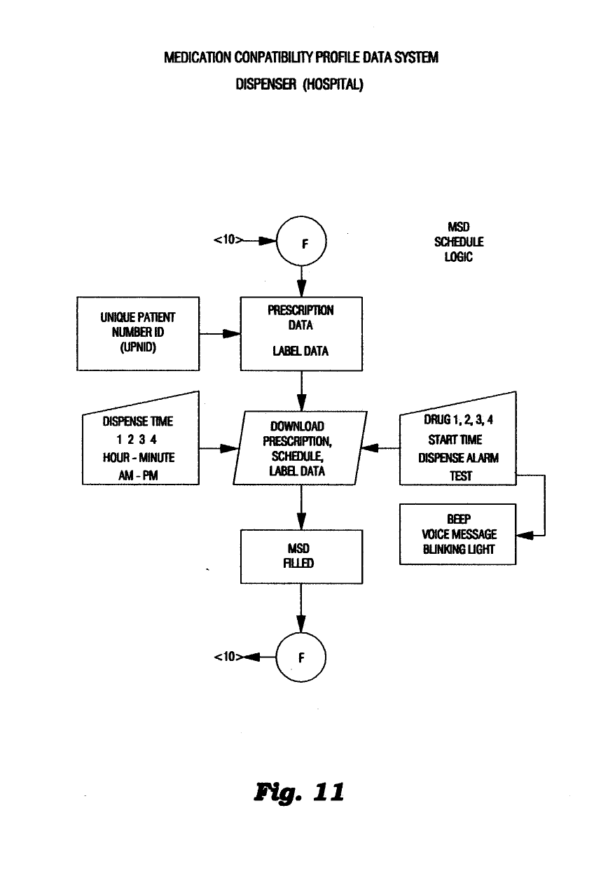

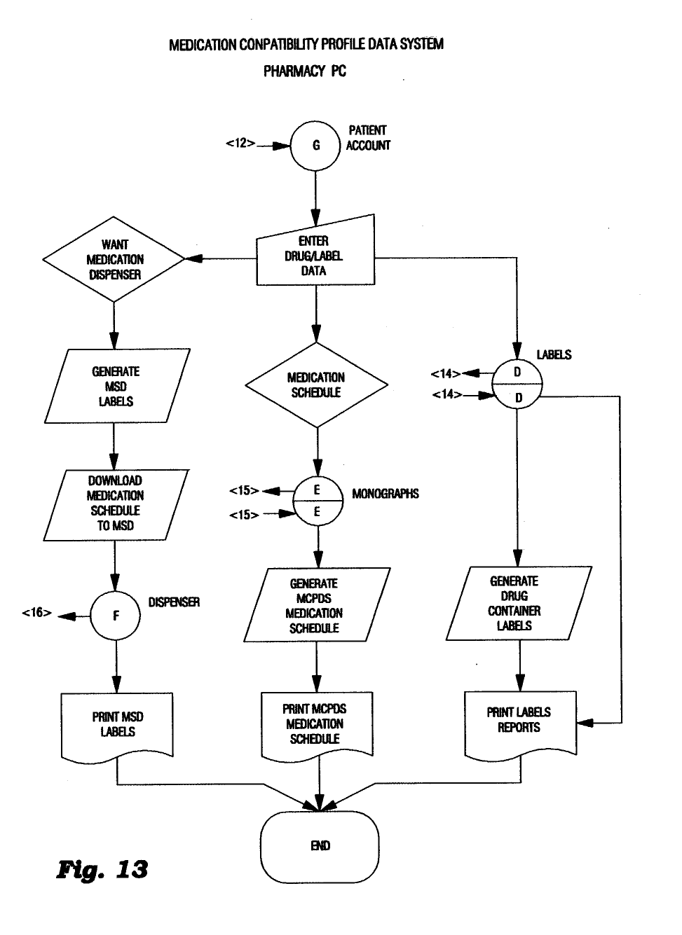

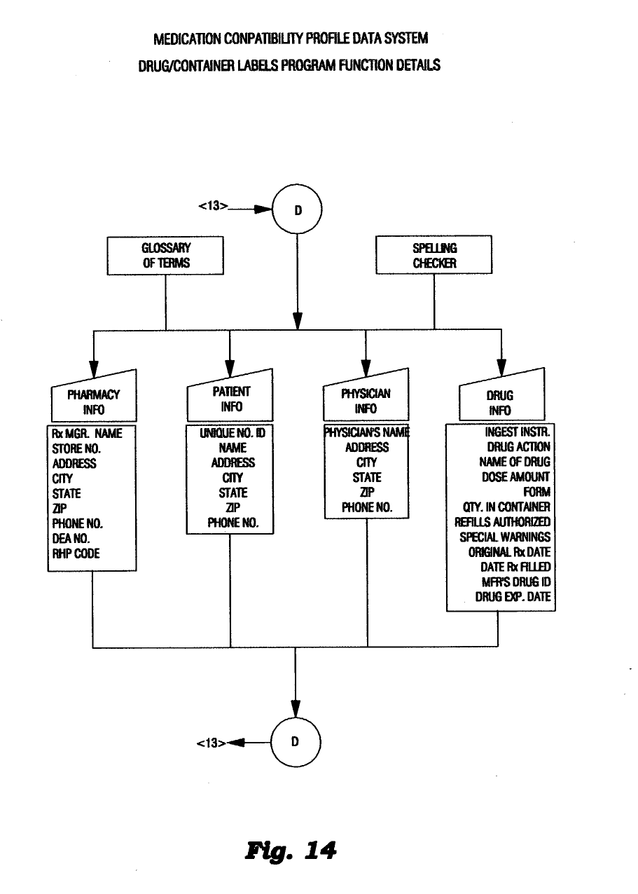

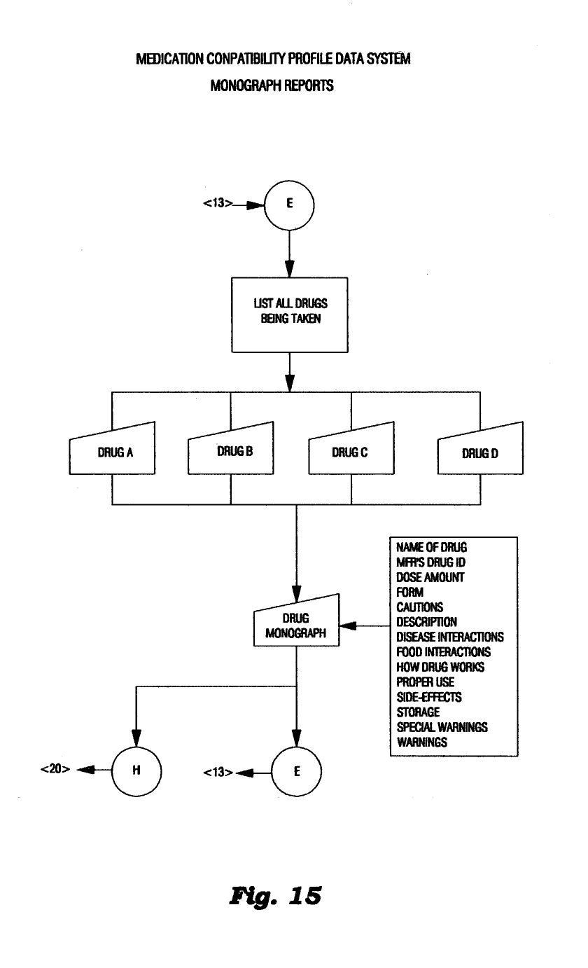

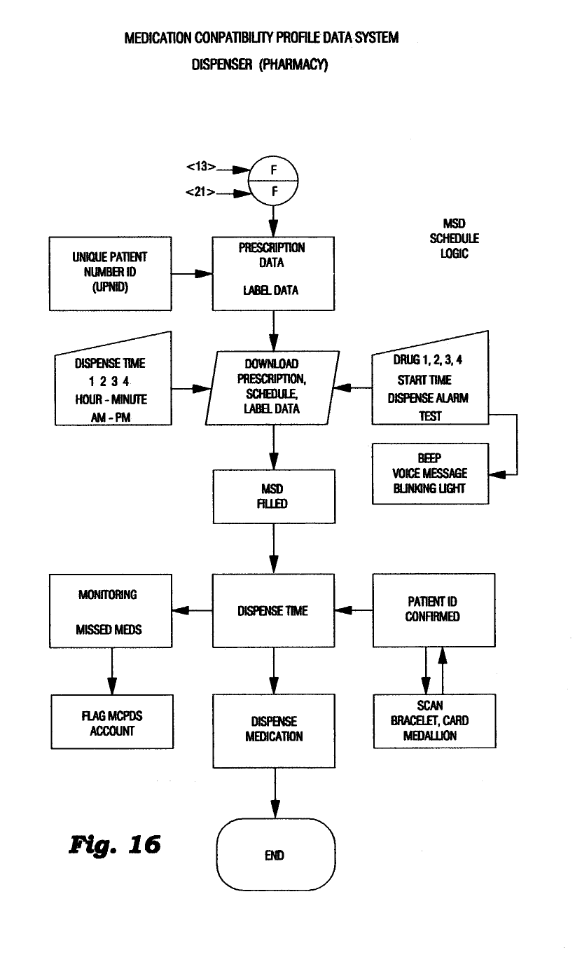

(3) The hospital pharmacy may then download a hospital patient's Medication Schedule to an MCPDS Medication Safety Dispenser (MSD). The MSD display panel lists the patient's ⁽¹⁾Name, ⁽²⁾ID Number, ⁽³⁾Room Number, ⁽⁴⁾Physician's Name, and ⁽⁵⁾Physician Contact Info, and ⁽⁶⁾time/date of next medication dispenser event. See FIG. 9 through FIG. 16 for logic flow detail operations performed by the MCPDS program in development of the Medication Schedule and programming of an MCPDS medication safety dispenser.

(4) The programmed MSD is then sent from the hospital pharmacy to the Appropriate Nurse's Station. All Pharmaceuticals are secured in the individual patient MSD units. Upon Nurse's Station receipt, delivery is verified by automatic login to the proper Nursing Station MCPDS Computer, preventing accidental delivery to any other hospital nurse's station. If the MSD will not login or is not logged, a notification is sent to the hospital pharmacy identifying medication delivery failure and prompting immediate response to recover the missing MSD.

(5) After proper delivery of an MSD to the nurse's station, the patient's medication may be administered within the proper MSD medication delivery protocol. Once the MSD is loaded with prescribed pharmaceuticals, the unit will only dispense medication when the patient's ID Bracelet is scanned and identified by the MSD unit electronic reader at the scheduled medication time. The Patient's MSD must be placed in proximity to the patient's hospital ID bracelet for scanning. The MSD patient identification protocol will mitigate or totally eliminate medicating a patient with anything other than the physician prescribed pharmaceuticals.

(6) After all MSD medication safety delivery protocols have been satisfied and the patient has consumed scheduled medication, the MSD unit is placed in data transmission proximity of the Nurse's Station MCPDS computer which receives and logs the medication delivery event into the MCPDS Hospital network database which then updates pharmacy and physician MCPDS accounts.

II. Pharmacists

(A) Pharmacy PC

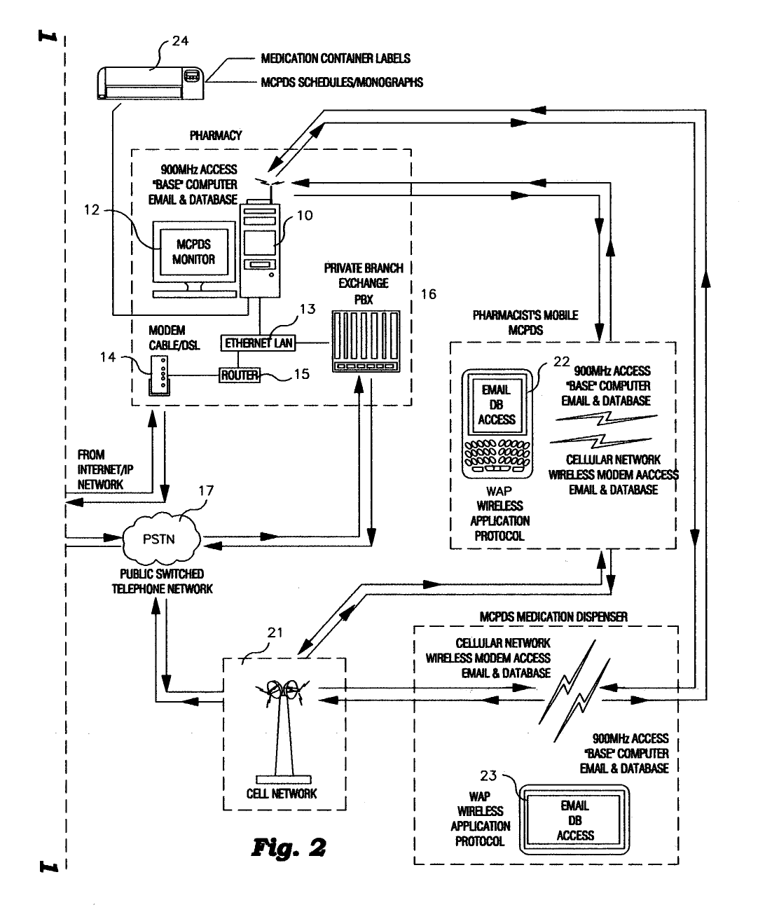

(1) Referring initially to FIG. 2, using the pharmacy personal computer system FIG. 2, item 10, a secure Login code is entered to access Pharmacist's account in MCPDS Internet online database through wired or wireless connections to a local area network (LAN) device FIG. 2, item 13, Internet connection router FIG. 2, item 15, appropriate dial-up-cable-DSL modem FIG. 2, item 14, to the Internet Providers network FIG. 2, item 18. At least one unique and secure account access code is assigned to each Pharmacist master account containing all customer data. Individual customer accounts may again be password protected to provide a second level of security for customer/patient medical information.

(2) After successful secure login to the pharmacist's customer MCPDS database account, separate customer accounts may be created and accessed. Each customer file is unique and accessible only by pharmacist's unique login security code.

(3) Every database and individual account access is marked and logged. Every access and data entry activity to accounts are automatically date and time stamped by the MCPDS program.

(4) Prescribed medication data is entered into an individual customer database. MCPDS protocols will notify the prescribing physician's MCPDS patient account when data is entered affecting the physician's patient. If multiple substances are prescribed, the MCPDS program will generate an MCPDS Medication Schedule and monograph report for review by both pharmacist and customer which can then be printed and delivered to the customer by the pharmacist. Other substances such as supplements and herbs, presently being consumed, may also be entered and the monographs for those elements will also be used by MCPDS to develop the Medication Schedule. See FIGS. 19 and 20 for logic flow detail operations performed by the MCPDS program in development of the Medication Schedule.

(5) All information, notes and comments necessary to administer medical care for an individual customer are entered into that customer's unique pharmacy record files in the MCPDS secure Internet online database 20, which can be accessed by authorized persons, from any location through an Internet connection. Pharmacists may also maintain their own Internet MCPDS server computer system for added security and restricted possession of the information stored in the MCPDS server database.

(6) Through the MCPDS Internet network, a secure transmission of prescription orders may be received by a designated Pharmacy. The pharmacist receipt of electronically transmitted prescription data, directly from the customer's physician the pharmacy computer via secure email, eliminates copy errors and mistranslation of prescription details.

(7) Pharmacy Customer File Data Review. After review and verification of prescription data, the MCPDS program will generate a Medication Schedule and monograph report which can be printed and delivered to the patient. Other substances such as supplements and herbs, presently being consumed, may also be entered and the monographs for those elements will also be used by MCPDS to develop the Medication Schedule.

(8) Individual Drug Container labels are prepared and generated by the MCPDS program.

(9) Financial transaction data is stored in pharmacy database for its own accounting purposes.

(10) If deemed necessary, the pharmacist may elect to provide controlled substances to a customer in a sealed MCPDS medication safety dispenser (MSD). The MCPDS program will also generate an MSD label and schedule for the drugs loaded into the MSD.

a. MCPDS Medication Schedule downloaded to MCPDS Dispenser microprocessor.

b. MCPDS Dispenser Bracelet Key/Necklace/Card. A bracelet containing a programmable security key is programmed to prompt the MSD, upon wireless recognition of security code, to release contained pharmaceuticals according to downloaded MCPDS Medication Schedule.

c. Tampering or forced extraction of pharmaceuticals will cause the MSD to notify the pharmacy and the customer's physician MCPDS account of suspicious event by telephone page message.

III. Alternative Health Care Professionals (AHCP)

(A) Store/Office PC

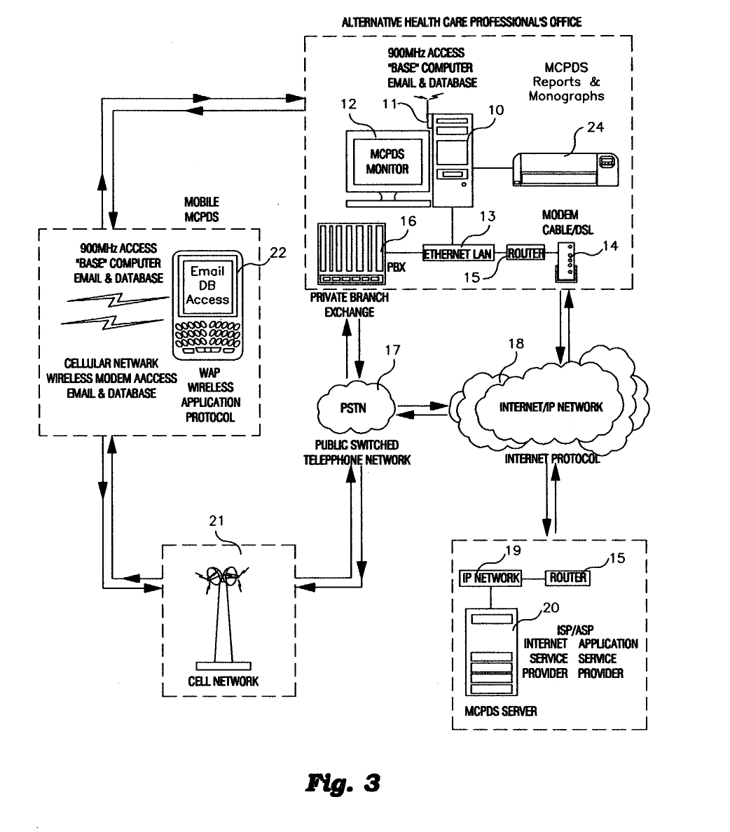

(1) Using the a personal computer system FIG. 3, item 10, a secure Login code is entered to access the AHCP's account in the MCPDS Internet online database through wired or wireless connections to a local area network (LAN) device FIG. 3, item 13, Internet connection router FIG. 3, item 15, appropriate dial-up-cable-DSL modem FIG. 3, item 14, to the Internet Providers network FIG. 3, item 18. At least one unique and secure account access code is assigned to each AHCP master account containing all customer data. Individual customer accounts may again be password protected to provide a second level of security for customer information security.

(2) After successful secure login to the AHCP's MCPDS customer database account, separate customer accounts may be created and accessed. Each customer file is unique and accessible only by AHCP's unique login security code.

(3) Every database and individual account access is marked and logged. Every access and data entry activity to accounts are automatically date and time stamped by the MCPDS program.

(4) Supplement and herb therapy data is entered into an individual customer database, if multiple substances are entered, the MCPDS program will generate an MCPDS Medication Schedule and monograph report for review by both the AHCP and the customer which can then be printed and delivered to the customer. Other substances such as prescribed drugs, presently being consumed, may also be entered and the monographs for those elements will also be used by MCPDS to develop the Medication Schedule. See FIGS. 19 and 20 for logic flow detail operations performed by the MCPDS program in development of the Medication Schedule.

(5) All information, notes and comments necessary to administer the MCPDS protocols for an individual customer are entered into that customer's record files in the MCPDS secure Internet online database 20, which can be accessed by authorized persons, from any location through an Internet connection. AHCP's may also maintain their own Internet MCPDS server computer system for added security and restricted possession of the information stored in the MCPDS server database.

(6) Through the MCPDS Internet network, a secure transmission of customer MCPDS data is communicated to the customer's physician's MCPDS patient record. This MCPDS attribute will notify the customer's physician about other therapies which may impact medical therapies. The electronic transmission of such data directly to the customer's MCPDS physician's patient account, eliminates copy errors and mistranslation of the data, and subsequently notifies the physician of other therapies being used by his patient.

(7) Alternative Health Care Professionals have no access to Physician or Pharmacy patient/customer MCPDS records. An individual customer may provide an AHCP with reference access to MCPDS account with a Personal Identification Number (P.I.N.), to allow correlation and notification of non-medication therapy to the physician's MCPDS patient account. Entry of purchased supplement and herb products into the Alternative Health Care Professional MCPDS database account will make it possible for the system to flag potential incompatibilities when a physician creates an MCPDS new patient account for the same individual. If the individual already has a physician MCPDS account, the Alternative Health Care Professional may access individual's account, with proper customer authorization, for data entry only. The AHCP may also review any current medication schedule in order to use the MCPDS program to prevent incompatibility between prescribed drugs and intended supplement purchases.

(8) The AHCP's Customer File Data Review. After review and verification of prescription data, supplied by customer, the MCPDS program will generate a Medication Schedule and monograph report which can be printed and delivered to the individual customer, which includes purchased substances and compatibility to prescribed medications.

(9) For. customers having no active MCPDS account the AHCP can create a new account and generate a comprehensive MCPDS Medication Schedule.

IV. Individuals

(A) Home PC

(1) An individual may create his own MCPDS account or access, for review only, his MCPDS account created by a physician, pharmacist, or Alternative Health Care Professional with a secure Login password. Each individual may access their own specific MCPDS account with a unique individual password. Individual access is restricted to access for review only. Individuals are prohibited from modifying any physician's, pharmacist's, or Health Care Professional's record. Each access to such records by an individual is fully documented in the respective database record system.

(2) An individual may generate a Medication Schedule using any one record maintained in the MCPDS database system of their own account, their own physician, pharmacist, or alternative health care professional. This function is accessible via Internet to individuals for the purpose of obtaining an MCPDS Medication Schedule compiled for supplement/herb consumption that may be contemplated or to replace a lost or missing Medication Schedule. Individuals have no access to Physician or Pharmacy patient/customer MCPDS records, if individuals would like to obtain an MCPDS Medication Schedule which includes supplements/herbs, secure access to is provided for producing Medication Schedule.

(3) Date & Time Record Created. Every individual access to MCPDS account is automatically date and time stamped by the MCPDS program.

V. MCPDS Medication Schedule Program Functions

MCPDS Program Functions are the tasks completed by the MCPDS software in order to address the following attributes of the medication error reduction system.

Electronic Data Entry

Verifiable Prescription Orders

Account Survey Capability

Bar-Coding and Wireless

Realtime Internet Database Network Technology

Electronic Medication Records

Inventory Management Administration

Interaction Database

Comprehensive cross-checking

Individual monographs for pharmaceuticals—supplements —herbs are stored in the MCPDS database. The monographs are compiled from published sources such as the United States Pharmacopoeia Drug Index (USP DI), and other authoritative sources which produce and publish such monographs.

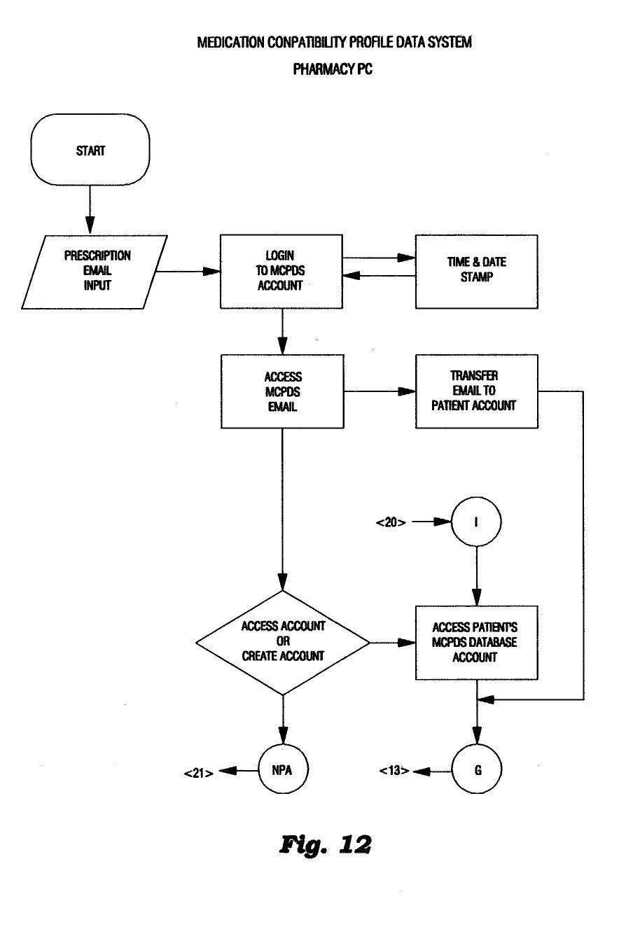

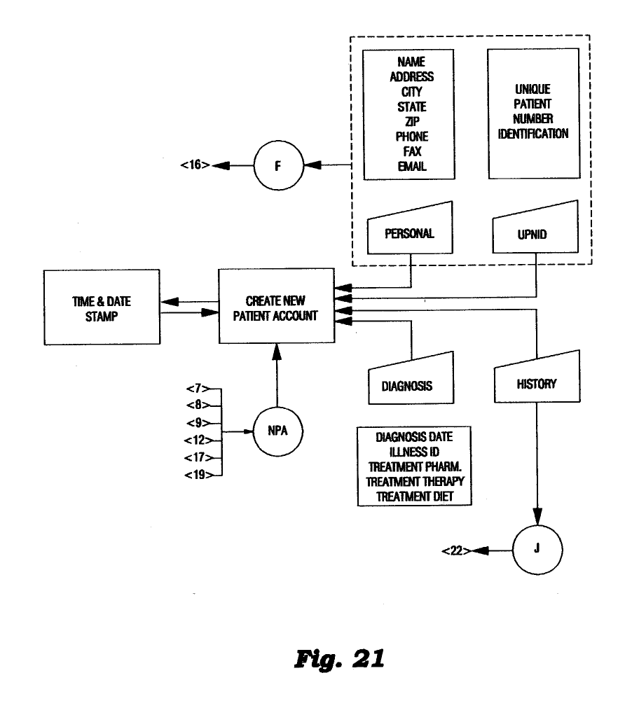

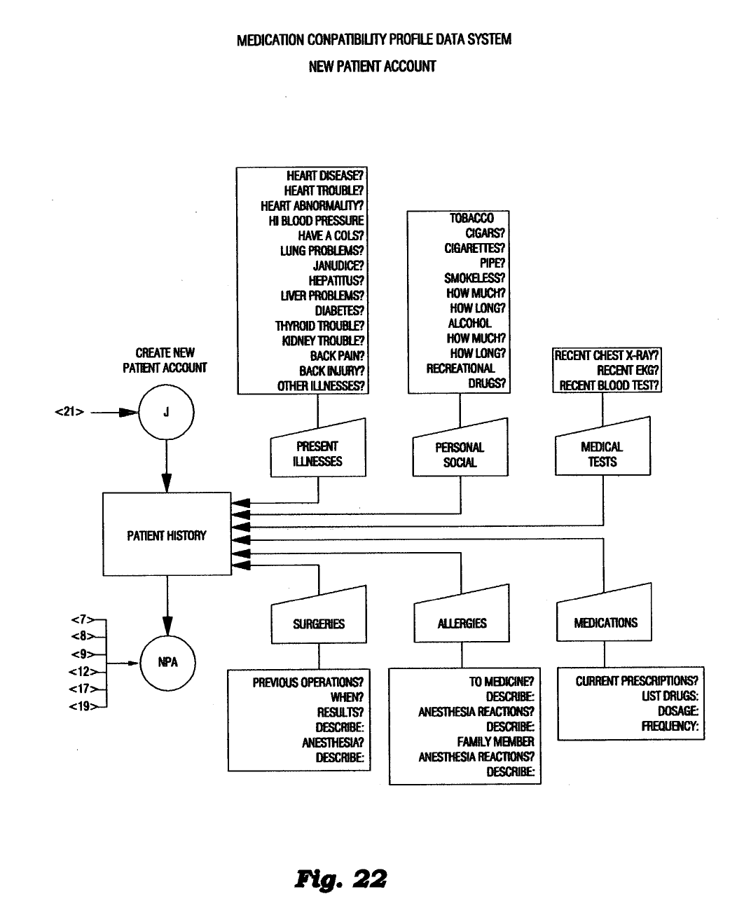

The logic flow chart group consisting of FIGS. 19, and 20, showing the inputs and outputs from logic flow chart group FIGS. 12, 13, 14, 15, 21, and 22, illustrates the logic sequence and the steps the system executes to produce an MCPDS Medication Schedule and associated monograph report when utilized by a pharmacist.

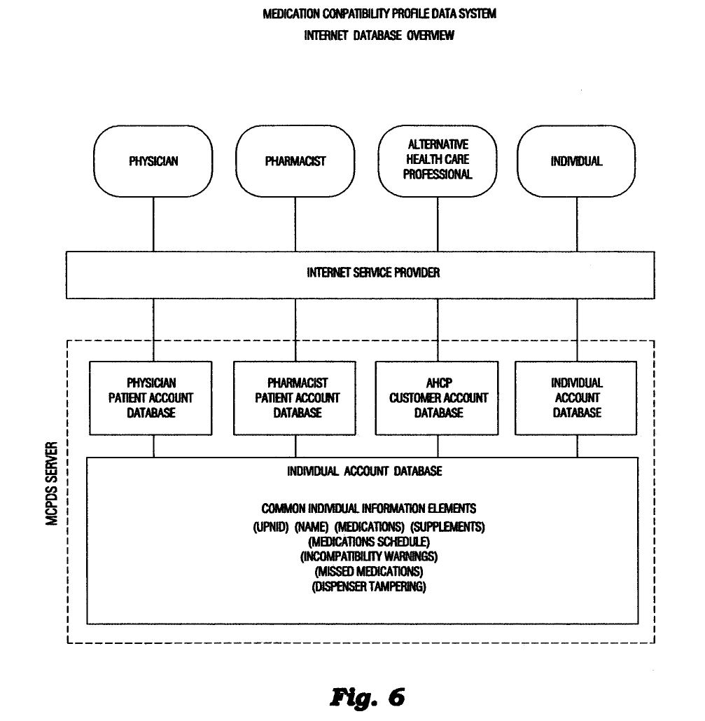

FIG. 6 shows the Internet database connectivity between physicians, pharmacists, health care professionals, and individuals.

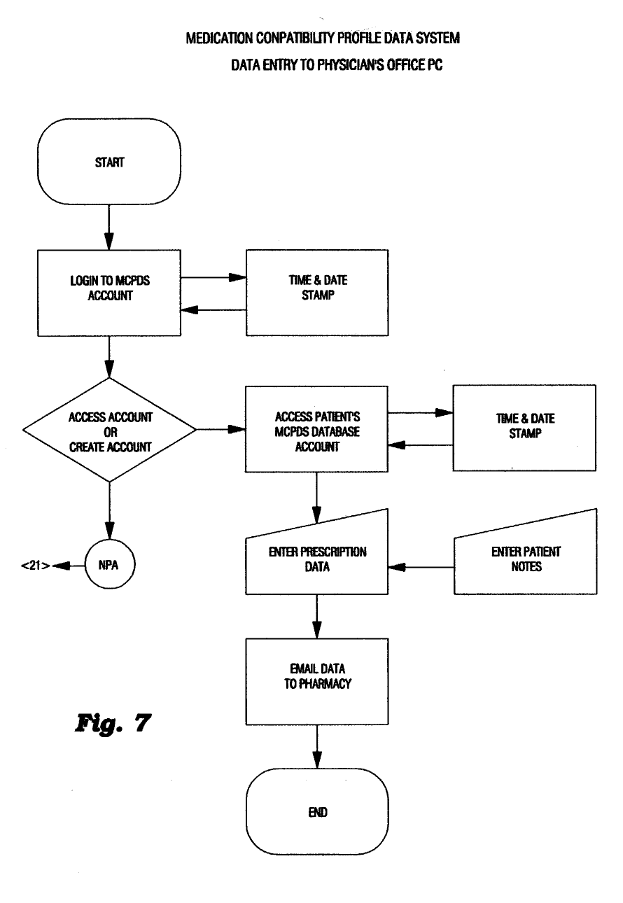

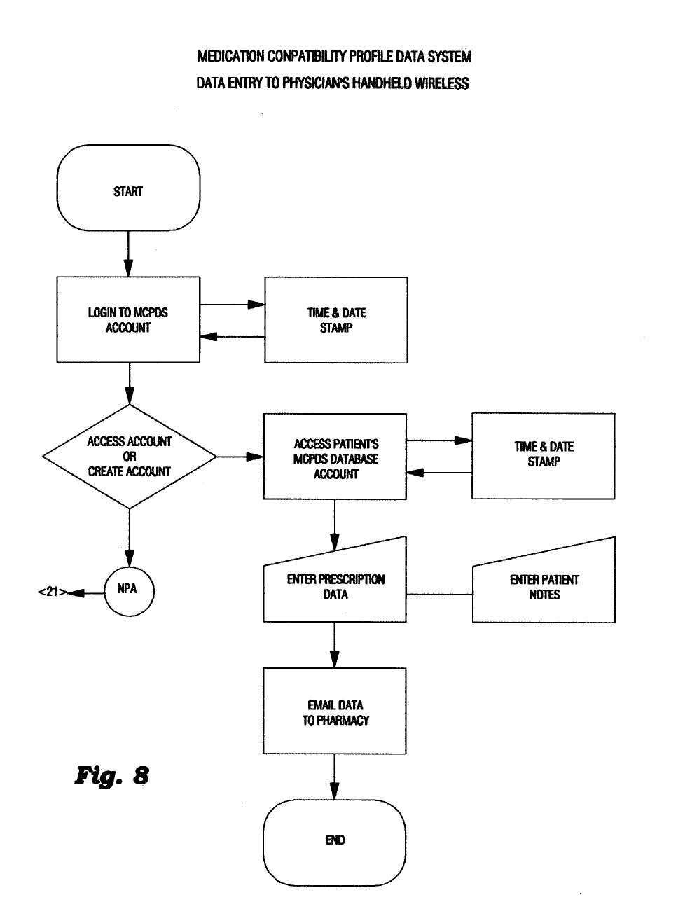

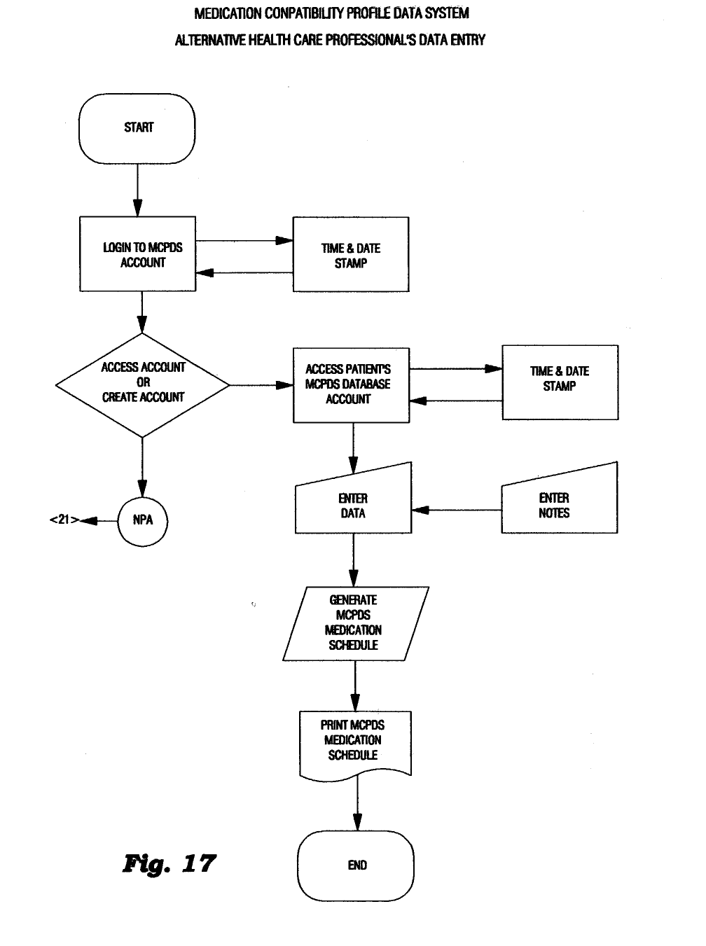

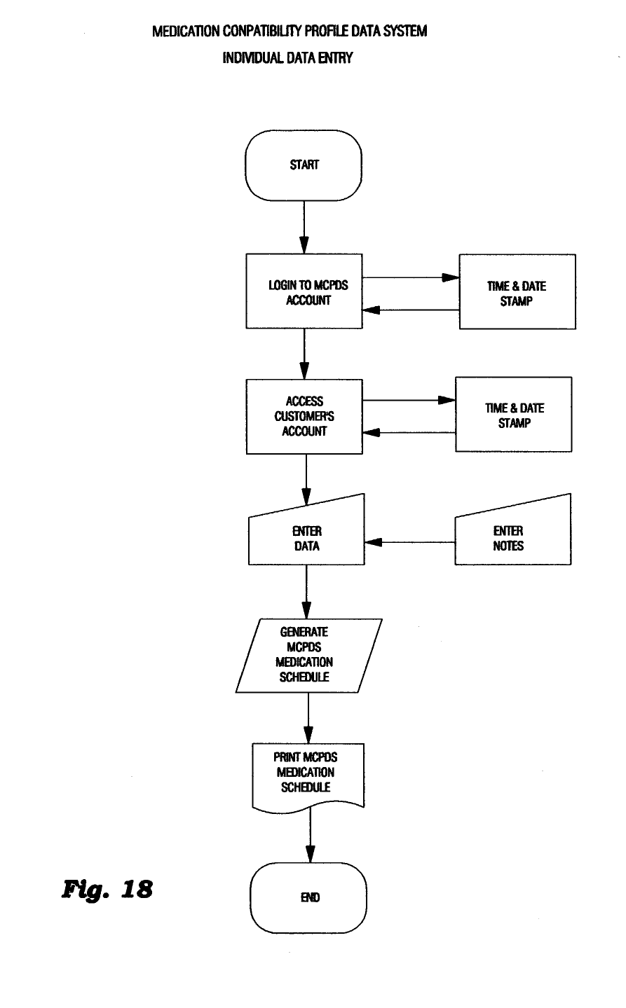

FIGS. 7, 8, 9, 10, 11, 16, 17, 18, 19, and 20, shows the logic sequence and the steps required to enter and manipulate the necessary information to protect medical patients from medication errors.

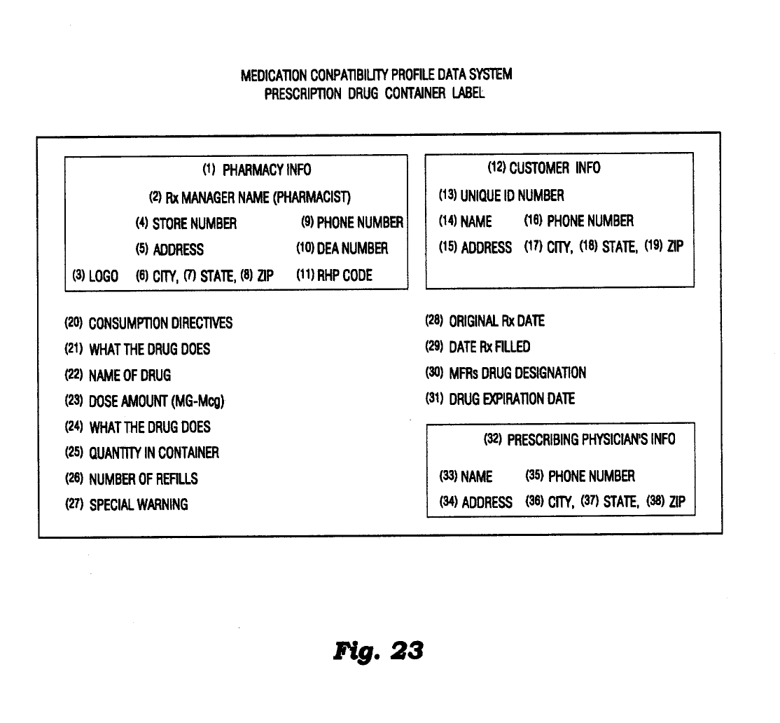

FIG. 23 shows the information elements required and produced by MCPDS for medication container labels.

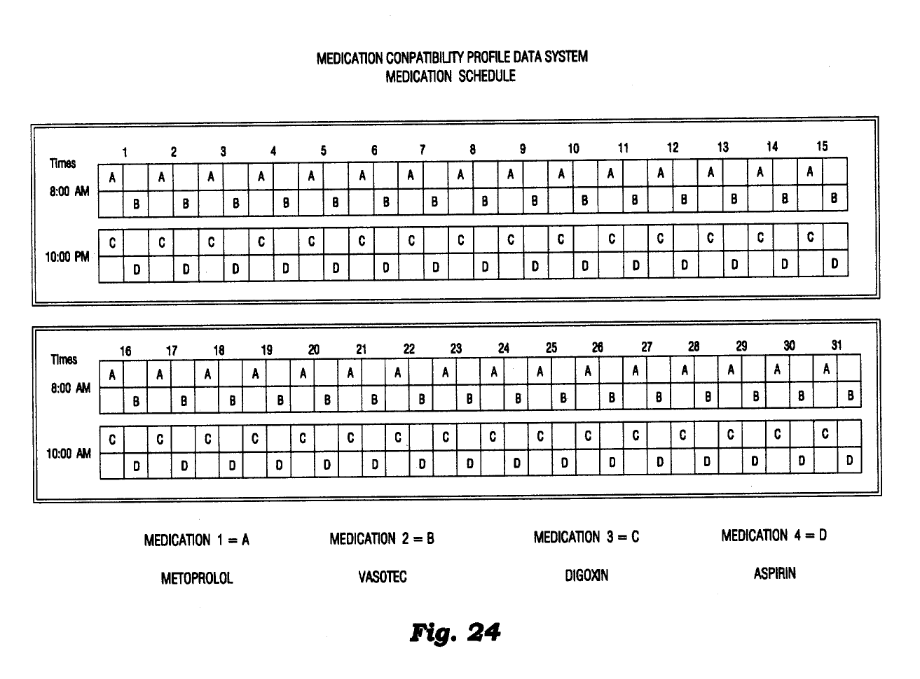

FIG. 24 shows what an MCPDS medication schedule would look like.

From the foregoing, it will be apparent to those skilled in the art that the business model system herein described permits convenient, integrated centralization in a communications network, of pertinent medical patient medication therapy information that will promote the highest degree of patient safety and security of personal medical information.

What is claimed is:

1. It is claimed that the Medication Compatibility Profile Data System business model will provide accurate data analysis and comparisons of multiple forms of medications—supplements—herbs.

2. It is claimed that the Medication Compatibility Profile Data System business model will accurately produce a medication schedule for the safe and proper consumption of multiple forms of medications—supplements—herbs.

3. It is claimed that the Medication Compatibility Profile Data System business model will accurately produce a medication schedule at speeds unattainable by any other method.

4. It is claimed that the Medication Compatibility Profile Data System business model will mitigate the incidence of injury and death caused by improper mixing of multiple forms of medications—supplements—herbs.

5. It is claimed that the Medication Compatibility Profile Data System business model will provide a more secure and reliable procedure for transmission of medication prescriptions between physicians and pharmacists.

6. It is claimed that the Medication Compatibility Profile Data System business model will provide prescription medication consumers with a nationwide network for secure access to individual medication records and profiles which will enhance accurate and competent medical treatment by physicians and hospital staff when the medication consumer is away from home.

7. It is claimed that the Medication Compatibility Profile Data System business model will provide pharmacists with an accurate database to effectively monitor prescription pharmaceutical sales and consumption for tighter management of controlled pharmaceutical substances.

8. It is claimed that the Medication Compatibility Profile Data System business model will provide a feedback mechanism, for tracking controlled substances, between pharmacists and physicians which is virtually non-existence at present.

9. It is claimed that the Medication Compatibility Profile Data System business model and medication dispenser will effectively prevent misuse and abuse of prescription controlled substances.

10. It is claimed that the Medication Compatibility Profile Data System business model will provide a real-time communications network availability between physicians and pharmacists which will enhance the safe and accurate dissemination of pharmaceuticals.

11. It is claimed that the Medication Compatibility Profile Data System business model will provide holistic health practitioners with a database for analysis and development of safe consumption schedules with respect to consumption of prescription pharmaceuticals.

12. It is claimed that the Medication Compatibility Profile Data System business model will provide holistic health practitioners with a database for analysis and development of safe consumption schedules with respect to consumption of certain foods.

13. It is claimed that the Medication Compatibility Profile Data System business model will provide holistic health practitioners with a database for analysis and development of safe consumption schedules with respect to consumption of dietary supplements.

14. It is claimed that the Medication Compatibility Profile Data System business model will provide holistic health practitioners with a database for analysis and development of safe consumption schedules with respect to consumption of herbal supplements.

15. It is claimed that the Medication Compatibility Profile Data System business model will provide holistic health practitioners with a database for analysis and development of safe consumption schedules with respect to consumption of homeopathic products.
